(19) United States
(12) Patent Application Publication
(10) Pub. No.: US 2021/0221648 A1
(43) Pub. Date: Jul. 22, 2021

(54) ANTI-PINCH DEVICE, SPACE COMPUTING DEVICE AND HOVERING CONTROL DEVICE

(71) Applicant: PixArt Imaging Inc., Hsin-Chu City (TW)

(72) Inventors: Tsung-Fa Wang, Hsin-Chu City (TW); Chiung-Wen Lin, Hsin-Chu City (TW); Tzung-Min Su, Hsin-Chu City (TW); Jeng-Yue Weng, Hsin-Chu City (TW); Ting-Yang Chang, Hsin-Chu City (TW); Chun-Sheng Lin, Hsin-Chu City (TW)

(21) Appl. No.: 17/131,795

(22) Filed: Dec. 23, 2020

Related U.S. Application Data
(60) Provisional application No. 62/963,179, filed on Jan. 20, 2020.

(51) Int. Cl. B66B 13/26; G06T 7/70; G01V 8/12; G05B 15/02

(52) U.S. Cl. CPC B66B 13/26; G06T 7/70; G06F 3/02; G05B 15/02; G01V 8/12

(57) ABSTRACT

In the present invention, an anti-pinch device which uses a simple optical mechanism to prevent the user being hurt by the moving part before the moving part touches the user is disclosed. Also, a space computing device which uses a simple optical mechanism to compute acquired space of a target object is disclosed. Additionally, a hovering control device which uses a simple optical mechanism thereby the user can control the hovering control device without touching the hovering control device is disclosed. The optical mechanism comprises at least one light source and at least one optical sensor, which can arrange in various ways.

### CROSS REFERENCE TO RELATED APPLICATIONS

This application claims the benefit of U.S. Provisional Application No. 62/963,179, filed on 2020 Jan. 20, the contents of which are incorporated herein by reference.

### BACKGROUND OF THE INVENTION

### 1. Field of the Invention

The present invention relates to an anti-pinch device, a space computing device and a hovering control device, and particularly relates to an anti-pinch device, a space computing device and a hovering control device which operate via optical mechanism.

### 2. Description of the Prior Art

An elevator is a very common apparatus in various buildings. A conventional elevator may comprise an anti-pinch device to prevent the door from hurting people. However, the conventional anti-pinch devices usually do not work until the door actually clamps things.

Besides, an elevator has limited space, but a conventional elevator always has no mechanism for computing occupied space and available space thereof. Therefore, a user may wait the elevator for a long time but finds the elevator is full when the elevator reaches.

Furthermore, a conventional elevator may have a control panel for controlling the operations thereof. Such conventional control panel needs a user to directly touch or press it, thus is not suitable for some situations. For example, diseases may be spread out via such control panel.

### SUMMARY OF THE INVENTION

Therefore, one objective of the present invention is to provide an anti-pinch device operates via a simple optical mechanism.

Another objective of the present invention is to provide a space computing device operates via a simple optical mechanism.

Still another objective of the present invention is to provide a hovering control device operates via a simple optical mechanism.

One embodiment of the present invention discloses an anti-pinch device for preventing a target object being pinched by a movable part. The anti-pinch device comprises: a light source, configured to emit light; an optical sensor, configured to sense optical data generated according to the light; and a processing circuit, configured to determine whether the target object exists between the movable part and a fixed part according to the optical data, to control the movable part accordingly.

Another embodiment of the present invention discloses a space computing device, for computing an occupied space of a target object. The space computing device comprises: a light source, configured to emit light; an optical sensor, configured to sense optical data generated according to the light emitted to the target object; and a processing circuit, configured to compute the occupied space of the target object according to the optical data.

The still another embodiment of the present invention discloses a hovering control device, for computing an occupied space of a target object. The hovering control device comprises: at least one light source, configured to emit light; at least one optical sensor, configured to sense optical data generated according to the light emitted to an object; a plurality of control regions; and a processing circuit, configured to control the hovering control device to generate a control command according to if the optical data represents that the target object stops at a location corresponding to a first control region.

In view of above-mentioned embodiments, an anti-pinch device which uses a simple optical mechanism to prevent the user being hurt by the moving part before the moving part touches the user is disclosed. Also, a space computing device which uses a simple optical mechanism to compute acquired space of a target object is disclosed.

Additionally, a hovering control device which uses a simple optical mechanism thereby the user can control the hovering control device without touching the hovering control device is disclosed.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1-FIG. 3 are schematic diagrams illustrating elevators according to embodiments of the present invention.

FIG. 4 is a schematic diagram illustrating a mechanical parking system which uses the anti-pinch device provided by the present invention.

FIG. 5-FIG. 7 are schematic diagram illustrating operations of a space computing device according to one embodiment of the present invention.

FIG. 8 is a schematic diagram illustrating a hovering control device according to one embodiment of the present invention.

FIG. 9 is a schematic diagram illustrating the operations of the hovering control device illustrated in FIG. 8.

FIG. 10 is a schematic diagram illustrating a hovering control device according to another embodiment of the present invention.

FIG. 11 is a schematic diagram illustrating the operations of the hovering control device illustrated in FIG. 10.

### DETAILED DESCRIPTION

Several embodiments are provided in following descriptions to explain the concept of the present invention. Each component in following descriptions can be implemented by hardware (e.g. a device or a circuit) or hardware with software (e.g. a program installed to a processor). Besides, the method in following descriptions can be executed by programs stored in a non-transitory computer readable recording medium such as a hard disk, an optical disc or a memory. Additionally, the term “first”, “second”, “third” in following descriptions are only for the purpose of distinguishing different one elements, and do not mean the sequence of the elements. For example, a first device and a second device only mean these devices can have the same structure but are different devices.

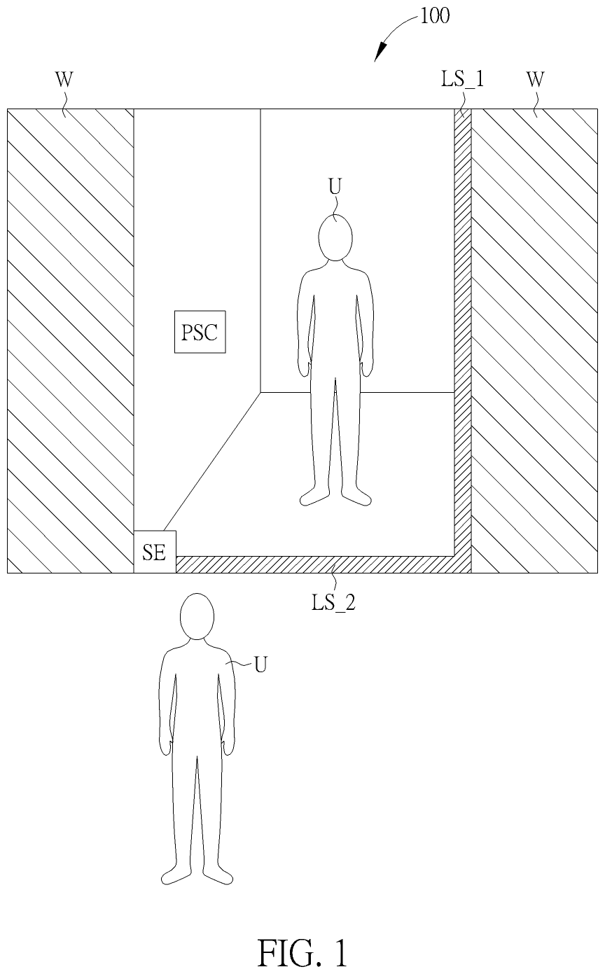

FIG. 1-FIG. 3 are schematic diagrams illustrating elevators according to embodiments of the present invention. As illustrated in FIG. 1, the elevator 100 comprises at least one light source LS_1, LS_2, an optical sensor SE (e.g., an image sensor) and a processing circuit (not shown). The light sources LS_1, LS_2, the optical sensor SE and the processing circuit in FIG. 1 form an anti-pinch device. The number of the light sources LS_1, LS_2 is 2 in this example, but is not limited. Also, the processing circuit can be, for example, a processor, or any circuit which is designed for performing following steps.

The light sources LS_1, LS_2 are configured to emit light. The optical sensor SE is configured to sense optical data (e.g., image, reflected light) generated according to the light. The optical data means images in this embodiment and following embodiments. Also, the processing circuit is configured to determine whether a target object exists between a movable part and a fixed part according to the optical data, to control the movable part accordingly. The light sources LS_1, LS_2 can be active light sources which generate light by themselves, such as LEDs (Light Emitting Diodes). However, the light sources LS_1, LS_2 can also be passive light sources. For example, the light sources LS_1, LS_2 can be reflective strips which reflect light from other light sources located opposite to the light sources LS_1, LS_2. The light source in other embodiments can also follow the same rules.

In the embodiment of FIG. 1, the target object can be a user U, and/or any stuff carried, pushed, or pulled by the user U. Further, the moving part in the embodiment of FIG. 1 is a door of the elevator 100. Additionally, the fixed part in the embodiment of FIG. 1 is the supporting object W (e.g., walls or pillars) near by the elevator 100. However, the fixed part, the movable part and the target object can be other objects if the concept illustrated in FIG. 1 is applied to other apparatuses, which will be described for more details later.

The light sources LS_1, LS_2 and the optical sensor SE can be provided at any locations of the elevator, such that the existence of the target object between the movable part and the fixed part can be detected but the opening and closing of the door are not interfered. The light from the light sources LS_1, LS_2 are blocked while the target object moving across the light sources LS_1, LS_2, such that the optical sensor SE can acquire optical data with at least one dark region. By this way, the processing circuit can determine the target object exists between the movable part and the fixed part if the optical data comprises at least one dark region. The processing circuit can further control the movable part according to the determination result. For example, if the determination result represents that the target object exists between the movable part and the fixed part, the processing circuit controls the elevator not to close the door or controls the door to move only for a short distance, to prevent the target object being pinched.

In one embodiment, the optical data sensed by the optical sensor SE is transformed form a 2D image to a 1D image. For example, each of pixels in one column of the 2D image is summed as a column value to generate the 1D image. Therefore, the 1D image includes a plurality of summed column values from the 2D image. When the target object passes through the door, the target object may stop light from the light sources LS_1, LS_2. Accordingly, a group of columns of the 1D image have column values below a specific threshold (dark region), which represent the target object passes the door.

In the embodiment of FIG. 1, the light sources LS_1, LS_2 and the optical sensor SE form an OTM (Optical Touch Monitor) structure. In other words, the light sources LS_1, LS_2 are opposite to the optical sensor SE or in a predetermined range opposite to the optical sensor. However, the numbers of the light sources and the optical sensor are not limited to the example illustrated in FIG. 1. For example, the number of the optical sensor SE can be 2 and the number of the light sources can be 2.

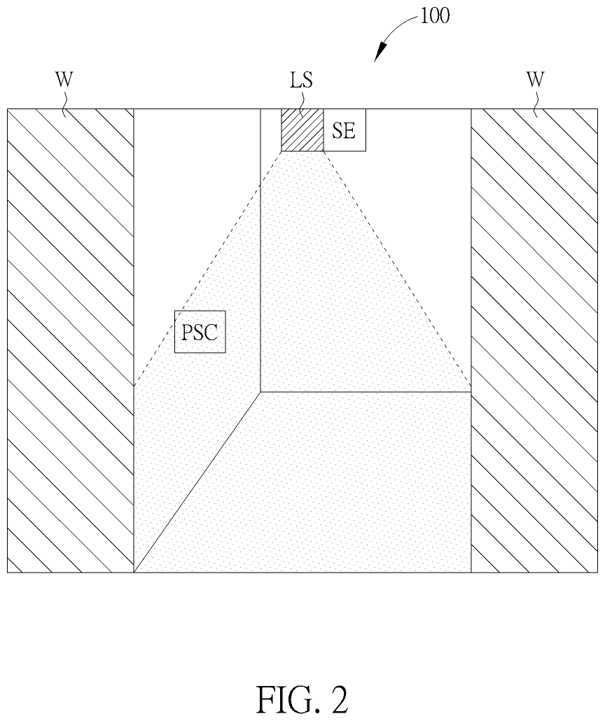

Further, the arrangements of the light sources and the optical sensor are not limited to the embodiment illustrated in FIG. 1. For example, in the embodiment of FIG. 2, the light source LS is nearby the optical sensor SE. In other words, the light source is in a predetermined range of the optical sensor, or the light source is in a predetermined range of the optical sensor at the same side. The anti-pinch device illustrated in FIG. 2 can also be named as a “depth sensing device”.

In one embodiment, the optical data sensed by the optical sensor SE is transformed form a 2D image to a 1D image. For example, each of pixels in one column of the 2D image is summed as a column value to generate the 1D image. Therefore, the 1D image includes a plurality of summed column values from the 2D image. When the target object passes through the door, the target object may reflect light of the light sources LS_1, LS_2. Accordingly, a group of columns of the 1D image have column values below a specific threshold (dark region), which represent the target object passes the door.

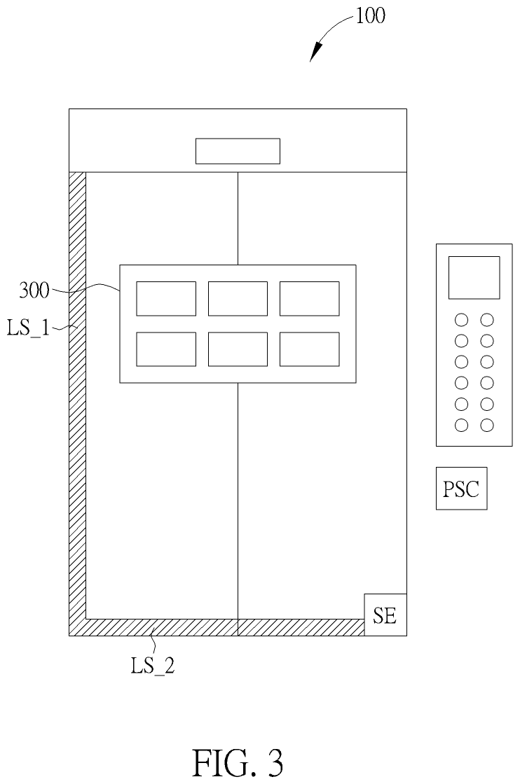

In one embodiment, the processing circuit is further configured to determine a location of a control object (e.g., a finger of the user) according to the optical data, and configured to control a device associated with an interactive interface according to a relative location between the control object and the interactive interface. As illustrated in the embodiment of FIG. 3, the control object is a finger of a user and the interactive interface is a scene 300. The scene 300 can be a projected image or an image displayed on a physical screen. The processing circuit can determine a location of the control object according sensed optical data, via the above-mentioned rules. Therefore, the user can move his finger to active the icon shown on the interactive interface, to trigger the operation of the device associated with the interactive interface. The device associated with the interactive interface can be, for example, a music player or a device which can control the displayed contents of the interactive interface. By this way, the user can enjoy some entertainments while in the elevator 100. Further, the interactive interface can also be used to control the up/down, door open/door close of the elevator 100.

Please note, although the embodiment illustrated in FIG. 3 applies the arrangements of light sources LS_1, LS_2, and the optical sensor SE in FIG. 1, but the embodiment illustrated in FIG. 3 can apply other arrangements of light sources and the optical sensor. As well For example, the embodiment illustrated in FIG. 3 can use the arrangements of light source LS and the optical sensor SE in the embodiment of FIG. 2.

The anti-pinch device disclosed in FIG. 1 and FIG. 2 can be applied to other kinds of apparatuses besides the elevator 100. For example, the anti-pinch device provided by the present invention can be applied to a manufacturing machine in a factory. In such case, the above-mentioned moving part and the fixed part are both components of the manufacturing machine, and the anti-pinch device provided by the present invention can prevent the employer from being pinched by the manufacturing machine.

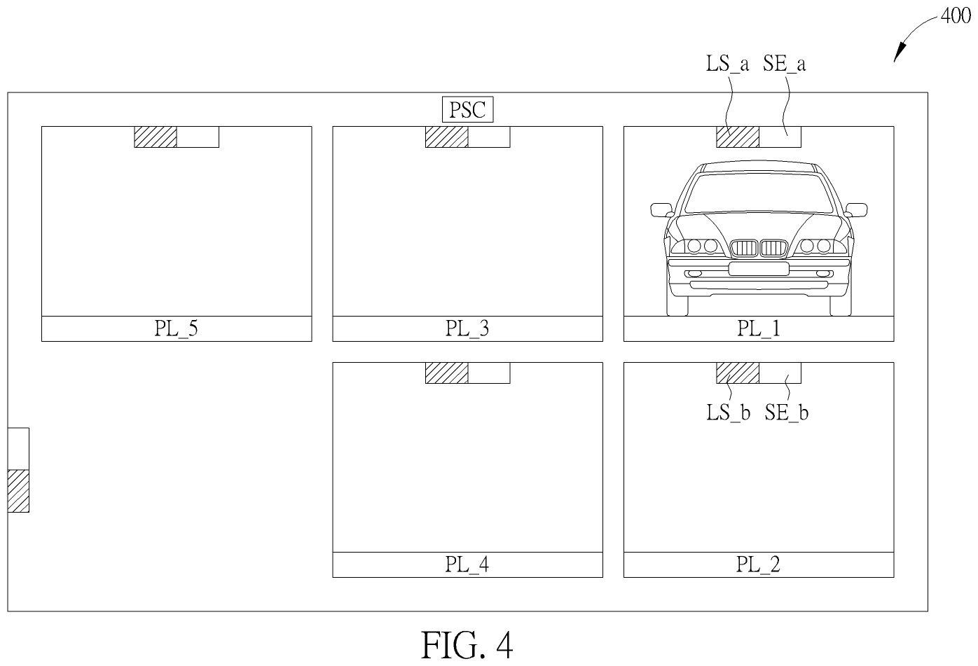

Besides the manufacturing machine, the anti-pinch device provided by the present invention can further be applied to a system comprising a fixed part which is fixed in a first state, and is movable in a second state. As shown in the embodiment of FIG. 4, the parking system 400 comprises a plurality of parking lots PL_1-PL_5. In one embodiment, if the use hopes to park his car into the parking lot PL_3, the parking lot PL_4 moves to the left and the parking lot PL_3 moves down, thereby the user can park his car into the parking lot PL_3. In such state, the parking lot PL_1 is a fixed part. In another state, if another user wants to move his car from the parking lot PL_1, the parking lots PL_2 and PL_4 moves to the left, and the parking lot PL_1 moves down. Therefore, in such state the parking lot PL_1 becomes to a movable part rather than a fixed part.

The above-mentioned anti-pinch device can be applied to the parking system 400 illustrated in FIG. 4. For example, via the light sources LS_a, LS_b, and the optical sensors SE a, SE_b, the processing circuit of the parking system can determine if any user enters the parking lots PL_1, PL_2, or if the user initially in the car already leaves the parking lot, to accordingly control the movement of the parking lots and prevent users being hurt due to the movements of the parking lots. For example, if a car enters the empty parking lot PL_2, the processing circuit of the parking system 400 determines a large object enters the parking lot PL_2 since a lot of reflected light of light from the light source LS_b is continuously received by the optical sensor SE_b. After that, if the reflected light of light from the light source LS_b increases for a short time and then goes back to the state for that the car is inside the parking lot PL_2, the processing circuit can determine that the driver of the car moves out. On the contrary, if the reflected light of light from the light source LS_b keeps the same after the car moves in, the processing circuit determines the driver of the car is still in the car. Variations of the concept disclosed in FIG. 4 should also fall in the scope of the present invention. The light source and the optical sensor can be provided to any location in the parking system 400 corresponding to different requirements.

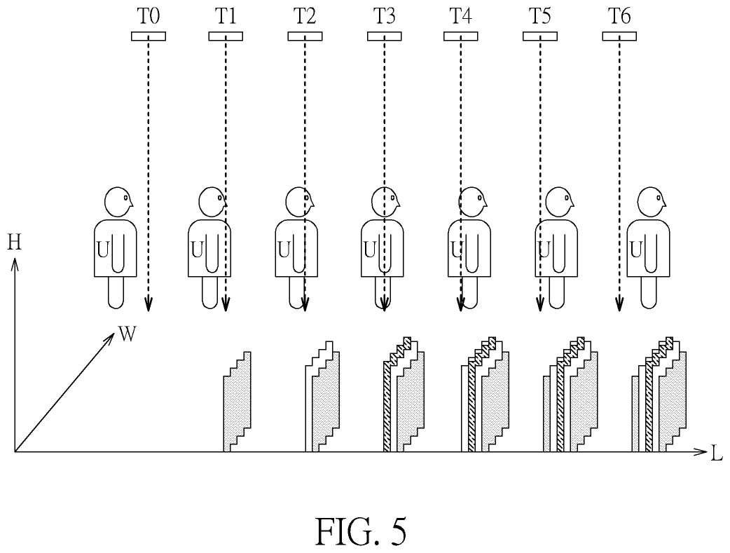

The anti-pinch device illustrated above can further be applied to calculate occupied space and/or available space. In such case, the anti-pinch device can be regarded as a space computing device. Please refer to FIG. 1 and FIG. 5 to understand the concept of the space computing device for more clarity.

In the embodiment of FIG. 5, the light sources LS_1, LS_2 in FIG. 1 are configured to emit light. The optical sensor SE is configured to sense optical data (image in this embodiment) generated according to the light. Also, the processing circuit is configured to compute the occupied space of the target object according to the optical data. In following embodiments, the target object can be a user, or any other stuff carried, pushed or pulled by the user. A user is taken as an example for explaining in following embodiments, but not limited.

As shown in FIG. 5, optical data at different time points T0-T6 are sensed by the optical sensor SE, and the user U moves through an illuminated area formed by the light from the light sources LS_1 and LS_2 during the time period comprising time points T1-T6. Since the user U moves through the illuminated area at time points T1-T5 but not at the time point T0 and the time point T6, the optical data at the time points T0 and T6 has no dark region and the optical data at different time points T1-T5 has dark regions with different sizes. The smaller the part of the user U is in the illuminated area, the smaller the dark region is. Similarly, the larger the part of the user U is in the illuminated area, the larger the dark region is. Therefore, via combining the optical data sensed at different time points, the occupied volume or the occupied area of the user U can be acquired. It will be appreciated that the time points T1-T6 mentioned here can mean short time periods rather than limited to particular time points.

Therefore, the processing circuit can compute a volume or an area occupied by the user U according to the optical data sensed at different time points when the user U moves through the illuminated area. If only one optical sensor is used, the processing circuit may only compute the area occupied by the user (i.e., compute 2D occupied space). If more than one optical sensor is used, the processing circuit may compute the volume occupied by the user (i.e., compute 3D occupied space) or computes a more precise occupied space.

For more detail, each image of the user at different time points can mean a 1D length or a 2D area of the user at the corresponding time point. For example, in the embodiment of FIG. 5, an image of the user U at the time point T3 can mean a 1D length or a 2D area of the user U at the Time point T3. Therefore, the volume or an area occupied by the user can be acquired via accumulating the 1D length or the 2D area at different time points. Take the embodiment in FIG. 5 as an example, if the accumulated 1D length of the user U computed based on the images acquired at the time points T1-T6 is A, the occupied area of the user U can be determined as A*K. K can be a predetermined value or a value acquired by a specific equation. For example, in one embodiment, K is proportional to a speed of the user U. Therefore, if a speed of the user U is higher than a speed threshold, the K is increased for X % while computing the occupied area of the user U. On the contrary, if the speed of the user U is lower than the speed threshold, the K is decreased for Y % while computing the occupied area of the user U. By this way, a more accurate occupied area of the user U can be acquired since the interference caused by different speeds of the user can be reduced. Such method can also be applied to compute an occupied volume of the user U.

The speed of the user U can be computed by various methods. For example, the speed can be estimated by the time that the user enters the illuminated area (e.g., the time point T1 in FIG. 5) and the time that the user leaves the illuminated area (e.g., the time point T6 in FIG. 5). For another example, another speed computing device, such as a radar speedometer or an optical speedometer, can be applied to compute the speed of the user.

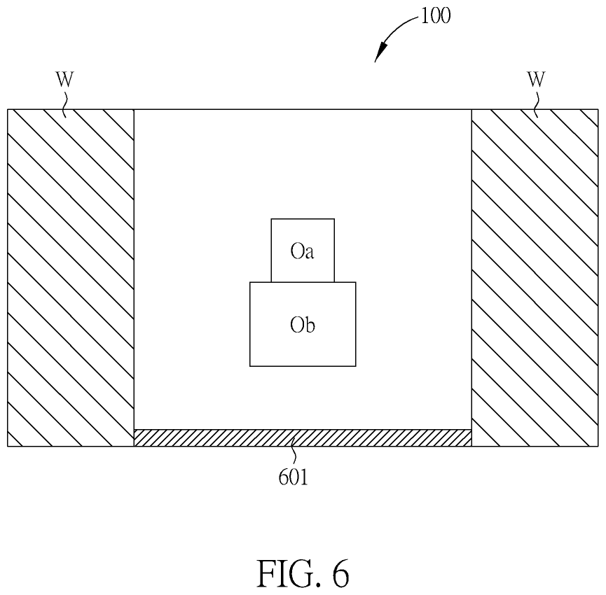

After acquiring the occupied area or the occupied volume, the processing circuit can further calculate an available space of the elevator 100 according to the occupied space and a total space of the elevator 100. FIG. 6 is a top view of the elevator 100 illustrated in FIG. 1. As shown in FIG. 1 and FIG. 6, the light sources LS_1, LS_2 and the optical sensor ES are provided at or near an entrance 601 (i.e., the door) of the elevator 100. Therefore, if any target object moves through the entrance 601, related optical data is sensed. Then, the occupied area and/or the occupied volume of the target object can be acquired. As illustrated in FIG. 6, the target object Oa means a baby stroller, and the target object Ob means a user. Following above-mentioned steps, the occupied area and/or the occupied volume of the target objects Oa, Ob can be acquired. If the total space of elevator 100 is already acquired, the available space can be calculated based on the maximum space and the occupied space of target objects. The space here can mean 2D space (i.e., area) or 3D space (i.e., volume).

Furthermore, besides using the space computing device illustrated in FIG. 1, the components (i.e., light sources and the optical sensor) of the space computing device provided by the present invention can have other arrangements. For example, the components of the space computing device may be arranged as the embodiment illustrated in FIG. 2. If the space computing device applies the arrangement illustrated in FIG. 1, the occupied area and/or the occupied volume is computed according dark regions of the optical data. However, if the space computing device applies the arrangement illustrated in FIG. 2, the occupied area and/or the occupied volume is computed according bright regions of the optical data. Further, it will be appreciated that the space computing device provided by the present invention is not limited to comprise components arranged in FIG. 1 and FIG. 2.

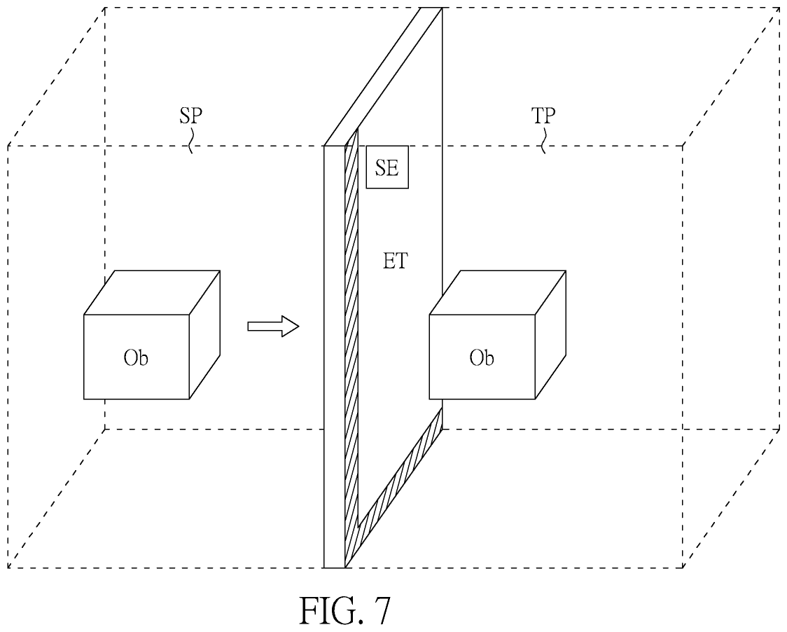

The space computing device provided by the present invention can be applied to any source space and any target space, rather than limited to the elevator 100. In the embodiment of FIG. 7, the space computing device in FIG. 1 is applied as an example for explaining. As illustrated in FIG. 7, the light sources LS_1, LS_2 and the optical sensor SE are provided in a predetermined range of an entrance ET. For example, the light sources LS_1, LS_2 and the optical sensor SE are provided at the entrance ET or near the entrance ET. By this way, the processing circuit computes the occupied space of the target object Ob after the target object Ob moves from a source space SP to a target space TP via the entrance ET and moves through the illuminated area generated by the light from the light sources LS_1, LS_2.

In the embodiments illustrated in FIG. 1, FIG. 2 and FIG. 5, the source space SP is an outside space of the elevator 100 and the target space TP is an inside space of the elevator 100. However, the source space SP and the target space TP can be any portions of any environment. For example, the target object Ob is a good on a conveyor which conveys the goods to a storeroom. Via the space computing device of the present invention, the available space of the store room can be acquired. For another example, the source space SP is an outside space of a tunnel and the target space TP is an inside space of the tunnel. Via the space computing device of the present invention, the occupied space of the vehicles in the tunnel can be acquired and the available space of the tunnel can also be acquired. Thereby the traffic flow of the tunnel can be correspondingly controlled.

The elevator always comprises a control panel for controlling door open/door close and move up/move down of the elevator. However, a conventional control panel needs a user to directly touch the button thereof, thus is not suitable for some situations, such as the elevator in the hospital. In following embodiments, the present invention provides hovering control devices which apply optical mechanisms, thereby users can control the elevator non-directly. Such hovering control devices can be applied to an elevator, and can be applied to any other electronic device.

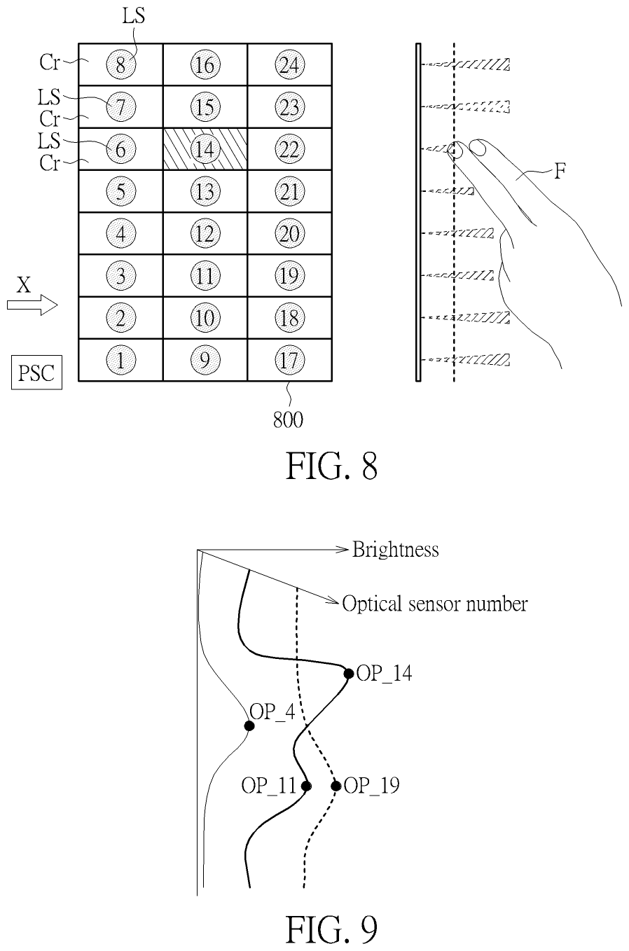

FIG. 8 is a schematic diagram illustrating a hovering control device 800 according to one embodiment of the present invention. The right figure of FIG. 8 is a schematic diagram viewed in the X direction of the left figure of FIG. 8. In the embodiment of FIG. 8, the hovering control device 800 comprises a plurality of control regions Cr (only three of them are marked). The control regions Cr can be control regions which can provide direct control, for example, hardware buttons or touch sensing devices such as a part of a touch board. However, control regions Cr can have no direct control functions such as portions of a plastic board or a glass board. A light source LS is provided for each one of the control regions Cr (only three of the light sources are marked). The light source LS can be provided on, under, or in the control region Cr. Besides the light sources LS, the hovering control device 800 further comprises at least one optical sensor for sensing optical data (not shown). The optical sensor can also be provided on, under, or in the control region Cr. In one embodiment, each one of the control regions Cr comprises a corresponding optical sensor.

In the embodiment of FIG. 8, if the finger F of an user is close to a specific control region Cr, the light from the light source LS of the specific control region Cr is reflected, thus the corresponding optical sensor may sense optical data with particularly high brightness (i.e., the brightness level is higher than a brightness threshold). In the embodiment of FIG. 8, the finger F is close to the control region Cr with number 14, which means the button to go to 14^{th} floor, thus the brightness of the optical data of the optical sensor OP_14 of the control region Cr with number 14 is particularly high, as illustrated in the curve chart shown in FIG. 9.

Light from light sources LS besides the control region Cr with number 14 may also be reflected by other portions of the user, for example, by the hand of the user. Accordingly, the optical data sensed by optical sensors of other control regions Cr may also become higher. For example, as shown in the curve chart illustrated in FIG. 9, brightness of the optical sensors OP_4, OP_11 and OP_14 which respectively correspond to the control regions with numbers 4, 11, 14 also become higher, but is still lower than brightness of the optical data of the optical sensor OP_14 (i.e. the brightness level is lower a than a brightness threshold). By this way, the processing circuit of the can determine the user wants to trigger the control region Cr with number 14.

In one embodiment, the hovering control device 800 further comprises a double confirm procedure to make sure which one of control regions Cr does the user want to trigger. In such embodiment, the processing circuit controls the hovering control device 800 to generate a confirm message if the optical data represents that the finger F stops at a location corresponding to a first control region among the control regions Cr, for example, the above-mentioned control region Cr with number 14. The processing circuit controls the hovering control device 800 to generate a control command corresponding to the first control region if a confirm operation corresponding to the confirm message is made. Also, the processing circuit does not control the hovering control device to generate the control command if the confirm operation is not made. The control command is used for controlling the elevator. For example, if the control region Cr with number 14 is really triggered, a control command for controlling the elevator to go to the 14^{th} floor is generated by the processing circuit.

In one example, the user wants to trigger the control region Cr with the number 12 but the processing circuit determines the user triggers the control region Cr with the number 13 due to the interference of other light sources. In such case, the control region Cr with the number 13 generates visible light (the confirm message) to inform the user that the control region Cr with the number 13 is triggered. In the user does not move his finger F after a predetermined time interval passed (confirm operation is performed), the hovering control device 800 triggers the control region Cr with the number 13 and generates a corresponding control command. On the opposite, if the user moves his finger F in the predetermined time interval (confirm operation is not performed), the hovering control device 800 does not trigger the control region Cr with the number 13 and the processing circuit re-determine which control region Cr does the user want to trigger.

The confirm message and the confirm operation can be changed corresponding to different requirements. For example, the confirm message can be changed to a voice message, and the confirm operation can be voice command generated by the user.

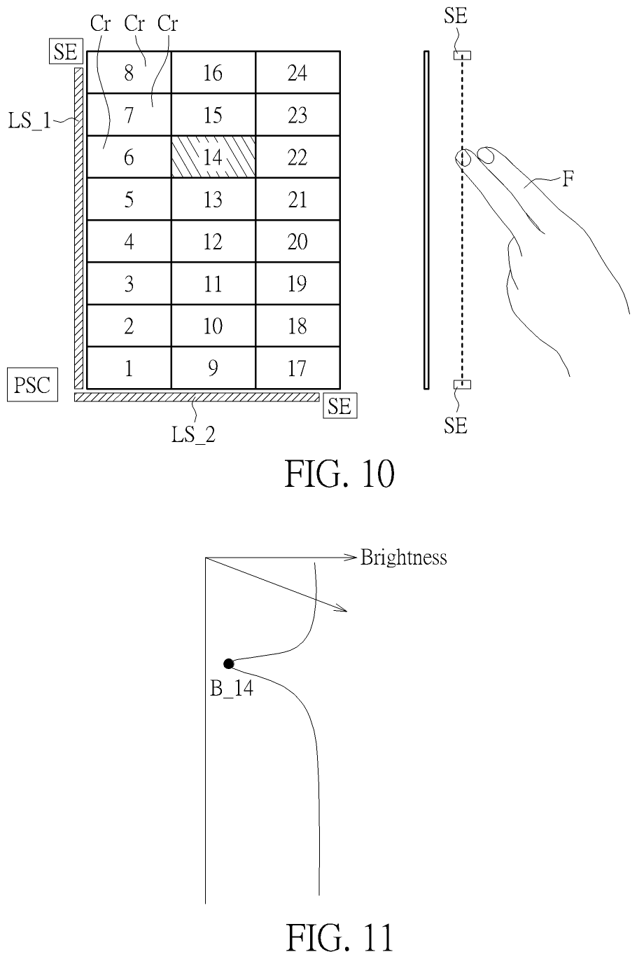

The arrangement of the light sources and the optical sensor of the hovering control device is not limited to the embodiment illustrated in FIG. 8. FIG. 10 is a schematic diagram illustrating a hovering control device 1000 according to another embodiment of the present invention. The right figure of FIG. 10 is a schematic diagram viewed in the X direction of the left figure of FIG. 10. The hovering control device 1000 comprises light sources LS_1, LS_2, an optical sensor SE and a processing circuit (not shown). The light sources LS_1, LS_2 and the optical sensor SE are outside the control regions Cr rather than below or on the control regions Cr.

The arrangement of the light sources LS_1, LS_2 and the optical sensor SE of the hovering control device 1000, which is also named the OTM structure, is similar with which of the anti-pinch device illustrated in FIG. 1. Therefore, in such case, the processing circuit determines the optical data represents that the target object stops at the location corresponding to the first control region if a brightness level of the optical data corresponding to the first control region is lower than a brightness threshold. For example, as illustrated in FIG. 11, the finger F is close to the control region Cr with number 14, thus the brightness corresponding to the control region Cr with number 14 becomes lower than the brightness threshold. By this way, the location of the finger F can be determined. After determining the location of the finger F, the above-mentioned double confirm procedure can also be performed, to make sure which control region does the user want to trigger.

In view of above-mentioned embodiments, an anti-pinch device which uses a simple optical mechanism to prevent the user being hurt by the moving part before the moving part touches the user is disclosed. Also, a space computing device which uses a simple optical mechanism to compute acquired space of a target object is disclosed.

Additionally, a hovering control device which uses a simple optical mechanism thereby the user can control the hovering control device without touching the hovering control device is disclosed.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. An anti-pinch device, for preventing a target object being pinched by a movable part, comprising:
a light source, configured to emit light;
an optical sensor, configured to sense optical data generated according to the light; and
a processing circuit, configured to determine whether the target object exists between the movable part and a fixed part according to the optical data, to control the movable part accordingly.

2. The anti-pinch device of claim 1, wherein the movable part is a door.

3. The anti-pinch device of claim 2, wherein the processing circuit is further configured to determine a location of a control object according to the optical data, and configured to control a device associated with an interactive interface according to a relative location between the control object and the interactive interface.

4. The anti-pinch device of claim 1, wherein the fixed part is fixed in a first state, and is movable in a second state.

5. The anti-pinch device of claim 1, wherein the movable part is a component of a machine.

6. The anti-pinch device of claim 1, wherein the light source is in a predetermined range opposite to the optical sensor.

7. The anti-pinch device of claim 1, wherein the light source is in a predetermined range of the optical sensor.

8. A space computing device, for computing an occupied space of a target object, comprising:
a light source, configured to emit light;
an optical sensor, configured to sense optical data generated according to the light emitted to the target object; and
a processing circuit, configured to compute the occupied space of the target object according to the optical data.

9. The space computing device of claim 8, wherein the processing circuit is configured to compute the occupied space of the target object after the target object moves through an illuminated area formed by the light.

10. The space computing device of claim 9, wherein the light source and the optical sensor are provided in a predetermined range of an entrance, wherein the processing circuit is configured to compute the occupied space of the target object after the target object moves from a source space to a target space via the entrance and moves through the illuminated area.

11. The space computing device of claim 10, wherein the processing circuit further calculates an available space of the target space according to the occupied space and a total space of the target space.

12. The space computing device of claim 9, wherein the processing circuit is configured to compute the occupied space of the target object, according to the optical data which are generated according to the light emitted to the target object and sensed by the optical sensor at different timings.

13. The anti-pinch device of claim 8, wherein the light source is in a predetermined range opposite to the optical sensor.

14. The anti-pinch device of claim 8, wherein the light source is in a predetermined range of the optical sensor.

15. A hovering control device, comprising:
at least one light source, configured to emit light;
at least one optical sensor, configured to sense optical data generated according to the light emitted to an object;
a plurality of control regions; and
a processing circuit, configured to control the hovering control device to generate a control command according to if the optical data represents that the target object stops at a location corresponding to a first control region.

16. The hovering control device of claim 15,
wherein the processing circuit controls the hovering control device according to if the optical data represents that the target object stops at the location;
wherein the processing circuit controls the hovering control device to generate the control command corresponding to the first control region if a confirm operation corresponding to the confirm message is made;
wherein the processing circuit does not control the hovering control device to generate the control command if the confirm operation is not made.

17. The hovering control device of claim 15, wherein the control regions are buttons or a part of a touch board.

18. The hovering control device of claim 15, wherein the confirm message is light generated by the first control region.

19. The hovering control device of claim 15, wherein each of the control regions comprises a corresponding one of the light source and a corresponding one of the optical sensors, and the processing circuit determines the optical data represents that the target object stops at the location corresponding to the first control region if a brightness level of the optical data corresponding to the first control region is larger than a brightness threshold.

20. The hovering control device of claim 15, wherein the optical sensor and the light source are outside the control regions, and the processing circuit determines the optical data represents that the target object stops at the location corresponding to the first control region if a brightness level of the optical data corresponding to the first control region is lower than a brightness threshold.
